(19) United States
(12) Patent Application Publication
(10) Pub. No.: US 2018/0309787 A1
(43) Pub. Date: Oct. 25, 2018

(54) DEPLOYING DECEPTION CAMPAIGNS USING COMMUNICATION BREADCRUMBS

(71) Applicant: Cymmetria, Inc., Palo Alto, CA (US)

(72) Inventors: Gadi EVRON, Eli (IL); Dean SYSMAN, Haifa (IL); Imri GOLDBERG, Kfar-Netter (IL); Shmuel UR, Shorashim (IL); Itamar SHER, Kiryat-Tivon (IL)

(21) Appl. No.: 15/770,785

(22) PCT Filed: Jul. 31, 2017
(86) PCT No.: PCT/IB17/54650

§ 371 Date: Apr. 25, 2018

Related U.S. Application Data
(60) Provisional application No. 62/369,116, filed on Jul. 31, 2016.

(51) Int. Cl. H04L 29/06; G06F 21/12

(52) U.S. Cl. CPC H04L 63/1491; G06F 21/121; H04L 63/1416

(57) ABSTRACT

A computer implemented method of detecting unauthorized access to a protected network by detecting a usage of dynamically updated deception communication, comprising deploying, in a protected network, a plurality of decoy endpoints configured to transmit one or more communication deception data objects encoded according to one or more communication protocols used in the protected network, instructing a first decoy endpoint of the plurality of decoy endpoints to transmit the communication deception data object(s) to a second decoy endpoint of the plurality of decoy endpoints, monitoring the protected network to detect a usage of data contained in the one or more communication deception data object, detecting one or more potential unauthorized operations based on analysis of the detection and initiating one or more actions according to the detection.

### BACKGROUND

The present invention, in some embodiments thereof, relates to detecting and/or containing potential unauthorized operations in a protected network, and, more specifically, but not exclusively, to detecting and/or containing potential unauthorized operations in a protected network by detecting potential unauthorized usage of deception network traffic injected into the protected network.

Organizations of all sizes and types face the threat of being attacked by advanced attackers who may be characterized as having substantial resources of time and tools, and are therefore able to carry out complicated and technologically advanced operations against targets to achieve specific goals, for example, retrieve sensitive data, damage infrastructure and/or the like.

Generally, advanced attackers operate in a staged manner, first collecting intelligence about the target organizations, networks, services and/or systems, initiate an initial penetration of the target, perform lateral movement and escalation within the target network and/or services, take actions on detected objectives and leave the target while covering the tracks. Each of the staged approach steps involves tactical iterations through what is known in the art as observe, orient, decide, act (OODA) loop. This tactic may present itself as most useful for the attackers who may face an unknown environment and therefore begin by observing their surroundings, orienting themselves, then deciding on a course of action and carrying it out.

### SUMMARY

According to a first aspect of the present invention there is provided a computer implemented method of detecting unauthorized access to a protected network by detecting a usage of dynamically updated deception communication, comprising:
Deploying, in a protected network comprising a plurality of endpoints, a plurality of decoy endpoints configured to transmit one or more communication deception data objects encoded according to at least one communication protocol used in the protected network.
Instructing a first decoy endpoint of the plurality of decoy endpoints to transmit the communication deception data object(s) to a second decoy endpoint of the plurality of decoy endpoints.
Monitoring the protected network to detect a usage of data contained in the one or more communication deception data object.
Detecting one or more potential unauthorized operations based on analysis of the detection.
Initiating one or more actions according to the detection.

Injecting the deception traffic (communication deception data objects) into the protected network using the deployed decoy endpoints and monitoring the protected network to detect usage of deception data contained in the communication deception objects may allow taking the initiative when protecting the network against potential (cyber) attacker(s) trying to penetrate the protected network. The potential attackers may be engaged at the very first stage in which the attacker enters the protected network by creating the deception network traffic. Moreover, while the currently existing methods are responsive in nature, i.e. respond to operations of the attacker, by creating the deception network traffic and leading the attacker's advance, the attacker may be directed and/or led to trap(s) that may reveal him. Furthermore, since the potential attacker(s) may be concerned that the network traffic may be deception traffic, the potential attacker(s) may refrain from using genuine (real) communication data objects transferred in the protected network as the potential attacker(s) may suspect the genuine data objects are in fact traps. In addition, creating, injecting and monitoring the deception traffic may allow for high scaling capabilities over large organizations, networks and/or systems.

According to a second aspect of the present invention there is provided a system for detecting unauthorized access to a protected network by detecting a usage of dynamically updated deception communication, comprising one or more processors of one or more decoy endpoints adapted to execute code, the code comprising:
Code instructions to deploy, in a protected network comprising a plurality of endpoints, a plurality of decoy endpoints configured to transmit one or more communication deception data objects encoded according to at least one communication protocol used in the protected network.
Code instructions to instruct a first decoy endpoint of the plurality of decoy endpoints to transmit the communication deception data object(s) to a second decoy endpoint of the plurality of decoy endpoints.
Code instructions to monitor the protected network to detect a usage of data contained in the communication deception data object(s).
Code instructions to detect one or more potential unauthorized operations based on analysis of the detection.
Code instructions to initiate one or more actions according to the detection.

According to a third aspect of the present invention there is provided a software program product for detecting unauthorized access to a protected network by detecting a usage of dynamically updated deception communication, comprising:
A non-transitory computer readable storage medium.
First program instructions for deploying, in a protected network comprising a plurality of endpoints, a plurality of decoy endpoints configured to transmit one or more communication deception data objects encoded according to at least one communication protocol used in the protected network.
Second program instructions for instructing a first decoy endpoint of the plurality of decoy endpoints to transmit the communication deception data object(s) to a second decoy endpoint of the plurality of decoy endpoints.
Third program instructions for monitoring the protected network to detect a usage of data contained in the communication deception data object(s);
Fourth program instructions for detecting one or more potential unauthorized operations based on analysis of the detection.
Fifth program instructions for initiating one or more actions according to the detection.

Wherein the first, second, third, fourth and fifth program instructions are executed by one or more processors from the non-transitory computer readable storage medium.

In a further implementation form of the first, second and/or third aspects, each of the plurality of endpoints is a physical device comprising one or more processors and/or a virtual device hosted by one or more physical devices. This may allow for high variability and flexibility of the protected network targeted by the traffic deception systems and methods. Moreover, this may allow for high flexibility and scalability in the deployment of a plurality of decoy endpoints of various types and scope.

In a further implementation form of the first, second and/or third aspects, one or more of the plurality of regular (general) endpoints are configured as one or more of the plurality of decoy endpoints. This may allow utilizing resources, i.e. regular endpoints already available in the protected network to create, configure and deploy one or more of the decoy endpoints. Configuring and deploying the regular endpoint(s) as decoy endpoint(s) may be done, for example, by deploying a decoy agent (e.g., an application, a utility, a tool, a script, an operating system, etc.) on the regular endpoint(s).

In a further implementation form of the first, second and/or third aspects, the communication deception data object(s) is a member of a group consisting of: a hashed credentials object, a browser cocky, a registry key, a Domain Network Server (DNS) name, an Internet Protocol (IP) address, a Server Message Block (SMB) message, a Link-Local Multicast Name Resolution LLMNR) message, a NetBIOS Naming Service (NBNS) message, a Multicast Domain Name System (MDNS) message and an Hypertext Transfer Protocol (HTTP). By selecting, configuring and encoding the communication deception data objects according to the communications protocols used in the protected network, the deception network traffic may appear as genuine network traffic which may lead the potential attacker(s) to believe the communication deception data objects are genuine (valid).

In an optional implementation form of the first, second and/or third aspects, the transmitting comprises broadcasting the communication deception data object(s) in the protected network. Broadcasting may allow making the communication deception data objects known and intercept able to the potential attacker(s) sniffing the protected network.

In an optional implementation form of the first, second and/or third aspects, at least two of the plurality of decoy endpoints are deployed in one or more segments of the protected network. Deploying the decoy endpoints in segments may allow adapting the decoy endpoints according to the characteristics of the specific segment, e.g. subnet, domain, etc.

In a further implementation form of the first, second and/or third aspects, the monitoring comprises monitoring the network activity in the protected network and/or monitoring access to one or more of the plurality of decoy endpoints. Monitoring the protected network by both monitoring the network activity itself and/or by monitoring access events to access the decoy endpoint(s), may allow for high detection coverage of the potential unauthorized operations(s). Moreover, this may allow taking advantage monitoring tools and/or systems already available in the protected network which may be used to detect the potential unauthorized operations(s).

In a further implementation form of the first, second and/or third aspects, the potential unauthorized operation(s) is initiated by a member of a group consisting of: a user, a process, an automated tool and a machine. The detection methods and systems are designed to detect a wide variety of potential attackers.

In an optional implementation form of the first, second and/or third aspects, a plurality of templates are provided for creating one or more of: the decoy endpoint(s) and/or the communication deception data object(s). Providing the templates for creating and/or instantiating the decoy endpoints, decoy agents executed by one or more endpoints may significantly reduce the effort to construct the deception network traffic and improve the efficiency and/or integrity of the deception network traffic.

In an optional implementation form of the first, second and/or third aspects, one or more of the plurality of templates are adjusted by one or more users according to one or more characteristic of the protected network. This may allow adapting the template(s) according to the specific protected network and/or part thereof in which the decoy endpoints are deployed.

In a further implementation form of the first, second and/or third aspects, the one or more actions comprise generating an alert at detection of the one or more potential unauthorized operation. This may allow one or more authorized parties to take action in response to the detected potential cyber security threat.

In a further implementation form of the first, second and/or third aspects, the one or more actions comprise communicating with a potential malicious responder using the one or more communication deception data object. This approach may be taken to address, contain and/or deceive responder type attack vectors.

In a further implementation form of the first, second and/or third aspects, one or more of the communication deception data objects relate to a third decoy endpoint of the plurality of endpoints. By referring to a plurality of endpoints and/or decoy endpoints in the communication deception data objects, the deception traffic and/or environment visible to the potential attacker(s) may seem highly reliable as it may effectively impersonate genuine network traffic.

In an optional implementation form of the first, second and/or third aspects, the potential unauthorized operation(s) is analyzed to identify one or more activity patterns. Identifying the activity pattern(s) may allow classifying the potential attacker(s) in order to predict their next operations, their intentions and/or the like. This may allow taking measures in advance to prevent and/or contain the next operations.

In an optional implementation form of the first, second and/or third aspects, a learning process on the activity pattern(s) to classify the activity pattern(s) in order to improve detection and classification of one or more future potential unauthorized operations. Using the machine learning to apply big data analytics may allow better classifying the potential attacker(s).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced

In the drawings:

FIG. 1 is a flowchart of an exemplary process of creating, injecting and monitoring deception traffic in a protected network to detect potential unauthorized operations, according to some embodiments of the present invention; and

FIG. 2 is a schematic illustration of an exemplary protected network comprising means for creating, injecting and monitoring deception traffic in the protected network to detect potential unauthorized operations, according to some embodiments of the present invention.

### DETAILED DESCRIPTION

The present invention, in some embodiments thereof, relates to detecting and/or containing potential unauthorized operations in a protected network, and, more specifically, but not exclusively, to detecting and/or containing potential unauthorized operations in a protected network by detecting potential unauthorized usage of deception network traffic injected into the protected network.

According to some embodiments of the present invention, there are provided methods, systems and computer program products for launching one or more deception campaigns in a protected network comprising a plurality of endpoints to identify one or more potential attackers by monitoring usage of deception data contained in deception traffic transmitted in the protected network. The deception campaign(s) comprise deployment of one or more decoys endpoints in the protected network and/or one or more segments of the protected network and instructing the decoy endpoints to transmit deception traffic in a protected network and/or part thereof. While one or more of the decoy endpoints may be created and configured as a dedicated decoy endpoint, one or more of the (general) endpoints in the protected network may be configured as the decoy endpoint by deploying a decoy agent on the respective endpoint(s). For brevity, the protected network and/or part thereof (i.e. segments) are referred to hereinafter as the protected network. The deception traffic may co-exist with genuine (real and valid) network traffic transferred in the protected network however the deception traffic may typically be transparent to legitimate users, applications, processes and/or the like of the protected network since legitimate users do not typically sniff the network. Moreover, the transmitted deception traffic has no discernible effect on either the general endpoints or the decoy endpoints in the protected network.

The deception traffic may include one or more communication deception data objects (traffic breadcrumbs) which may contain deceptive data configured to attract potential attacker(s) sniffing the network and intercepting communication data to use the communication deception data objects while performing the OODA loop within the protected network. The communication deception data objects may be configured and encoded according to one or more communication protocols used in the protected network, for example, a credentials based authentication protocol, a Domain Network Server (DNS) service, an Internet Protocol (IP) address based communication, a Server Message Block (SMB), a Link-Local Multicast Name Resolution LLMNR) service, a NetBIOS Naming Service (NBNS), a Multicast Domain Name System (MDNS), an Hypertext Transfer Protocol (HTTP), and/or the like. Configuring and encoding the communication deception data objects according to commonly used communication protocols may allow the deception traffic to emulate and/or impersonate as real, genuine and/or valid network traffic transferred in the protected network.

Optionally, one or more generic templates are provided for creating and/or configuring one or more of the deception network traffic elements, for example, the decoy endpoints, one or more services (agents) executed by the decoy endpoints and/or the communication deception data objects. The template(s) may be adjusted according to the communication protocols used in the protected network. The adjusted template(s) may be defined as a baseline which may be dynamically (automatically) updated in real time according to the detected unauthorized operation(s).

The deception campaign further includes monitoring the protected network to detect usage of the communication deception data object(s) and/or deception data contained in them. The usage of the communication deception data object(s) may be analyzed to identify one or more unauthorized operations which may be indicative of one or more potential attacker(s) in the protected network, for example, a user, a process, a utility, an automated tool, an endpoint and/or the like using the intercepted communication deception data objects to access resource(s) in the protected network. The detected unauthorized operation(s) may be further analyzed to identify one or more attack vectors applied to attack the resource(s) of the protected network.

Optionally, one or more activity patterns of the potential attacker(s) are identified by analyzing the detected unauthorized operation(s), in particular unauthorized communication operations. The activity pattern(s) may be used to gather useful forensic data on the operations. The activity pattern(s) may be further used to classify the potential attacker(s) in order to estimate a course of action and/or intentions of the potential attacker(s).

Optionally, one or more machine learning processes, methods, algorithms and/or techniques are employed on the identified activity pattern(s) to further collect analytics data regarding the activity patterns. Such machine learning analytics may serve to increase the accuracy of classifying the potential attacker(s) and/or better predict further activity and/or intentions of the potential attacker(s) in the protected network.

One or more actions may be initiated according to the detected unauthorized operation(s). Typically one or more alerts may be generated to indicate one or more parties (e.g. a user, an automated system, a security center, a security service etc.) of the potentially unauthorized operation(s).

Following the detection of the unauthorized operation(s), one or more additional actions may be initiated. For example, initiating additional communication session between the decoy endpoints to inject additional deception traffic into the protected network. Furthermore, one or more communication session may be established with the potential attacker(s) himself, for example, in case of a responder attack vector, a communication session(s) may be initiated with the responder device. The additional deception traffic may include one or more additional communication deception data objects automatically selected, created, configured and/or adjusted according to the detected unauthorized operations. Injecting the additional communication deception data objects (either between the decoy endpoints and/or with the attacker device) may serve a plurality of uses, for example, containing the detected attack vector, collect forensic data relating to the attack vector and/or the like.

The campaign manager may further adapt the deception traffic, i.e. the communication deception data objects to tackle an estimated course of action and/or intentions of the potential attacker based on the identified activity pattern(s) of the potential attacker(s), according to the classification of the potential attacker(s) and/or according to the predicted intentions of the potential attacker(s) as learned from the machine learning analytics.

Deploying the decoy endpoints in the protected network and injecting the deception network traffic into the protected network may present significant advantages compared to currently existing methods for detecting potential attackers accessing resources in the protected network. First as opposed to some of the currently existing methods that engage with the potential attacker at the act stage, the presented deception environment deceives the potential attacker from the very first stage in which the attacker enters the protected network by creating the deception network traffic. Engaging the attacker at the act stage and trying to block the attack as done by the existing methods may lead the attacker to search for an alternative path in order to circumvent the blocked path. Moreover, while the currently existing methods are responsive in nature, i.e. respond to operations of the attacker, by creating the deception network traffic and leading the attacker's advance, the initiative is taken such that the attacker may be directed and/or led to trap(s) that may reveal him. Furthermore, since the deception network traffic may be transparent to the legitimate users in the protected network, any operations involving deception data contained in the communication deception data objects may accurately indicate a potential attacker thus avoiding false positive alerts. In addition, since the potential attacker(s) may be concerned that the network traffic may be deception communication traffic, the potential attacker(s) may refrain from using genuine (real) communication data objects transferred in the protected network as the potential attacker(s) may suspect the genuine data objects are in fact traps.

Moreover, by dynamically (automatically) selecting, creating, updating and encoding the communication deception data objects according to the communications protocols used in the protected network, the deception network traffic may appear as real active network traffic which may lead the potential attacker(s) to believe the communication deception data objects are genuine (valid). As the potential attacker(s) may be unaware that the deception network traffic he intercepted is not genuine, the attacker may interact with the decoy endpoints during multiple iterations of the OODA loop thus revealing his activity pattern and possible intention(s). The deception network traffic, in particular the communication deception data objects may thus be adapted according to the identified activity pattern(s).

Furthermore, the presented deception traffic injection and monitoring methods and systems may allow for high scaling capabilities over large organizations, networks and/or systems. In addition, using the templates for creating and instantiating the decoy endpoints and/or decoy agents executed by the endpoints coupled with automated tools for selecting, creating and/or configuring the communication deception data objects according to the detected unauthorized operations may significantly reduce the effort to construct the deception network traffic and improve the efficiency and/or integrity of the deception network traffic. The centralized management and monitoring of the deception network traffic may further simplify tracking the potential unauthorized operations and/or potential attacks.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

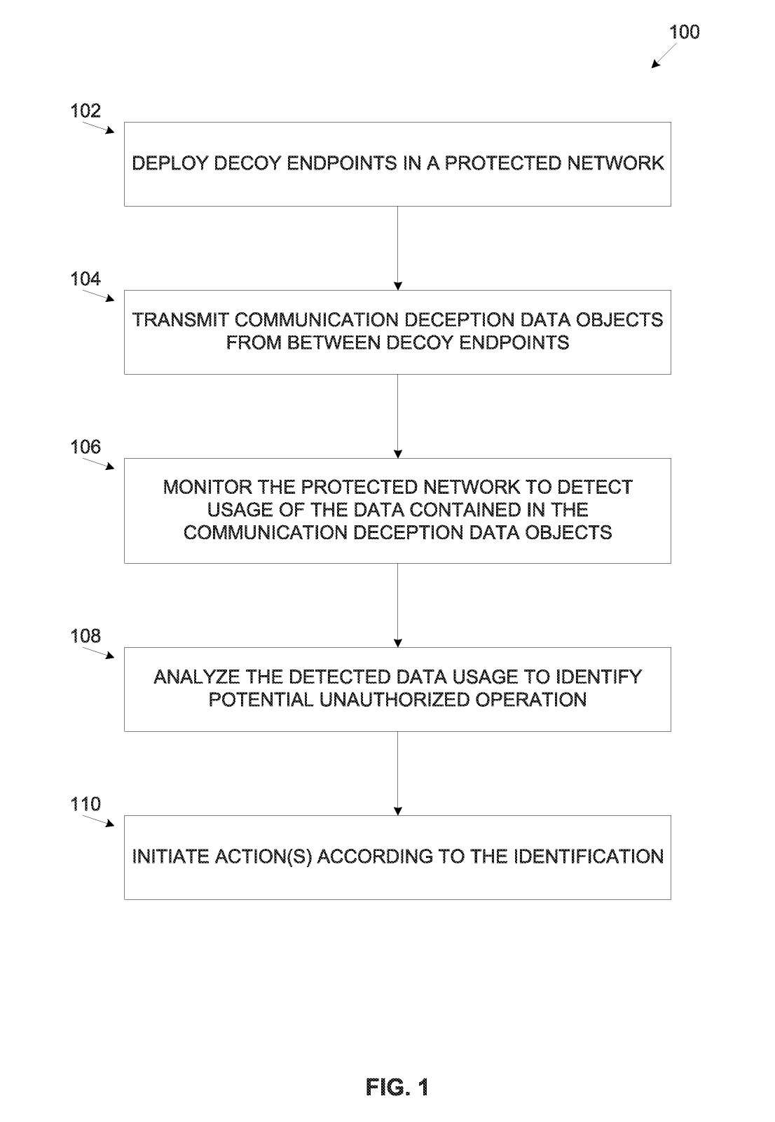

Referring now to the drawings, FIG. 1 is a flowchart of an exemplary process of creating, injecting and monitoring deception traffic in a protected network to detect potential unauthorized operations, according to some embodiments of the present invention. A process 100 is executed to deploy launch one or more deception campaigns comprising deployment of one or more decoys endpoints and instructing the decoy endpoints to transmit deception traffic in a protected network. The deception traffic may include one or more communication deception data objects (traffic breadcrumbs) which may contain deceptive data configured to attract potential attacker(s) sniffing the protected network and intercepting communication data to use the communication deception data objects while performing the OODA loop within the protected network. The communication deception data objects may be configured and encoded according to one or more communication protocols used in the protected network such that the deception traffic emulates and/or impersonates as real genuine and/or valid network traffic transferred in the protected network. The deception traffic may be transparent to legitimate users, applications, processes and/or the like of the protected network. Therefore, operation(s) in the protected network that use the data contained in the communication deception data object(s) may be considered as potential unauthorized operation(s) that in turn may be indicative of a potential attacker. Once the unauthorized operation(s) is detected, one or more actions may be initiated, for example, generating an alert, applying further deception measures to contain a potential attack vector and/or the like.

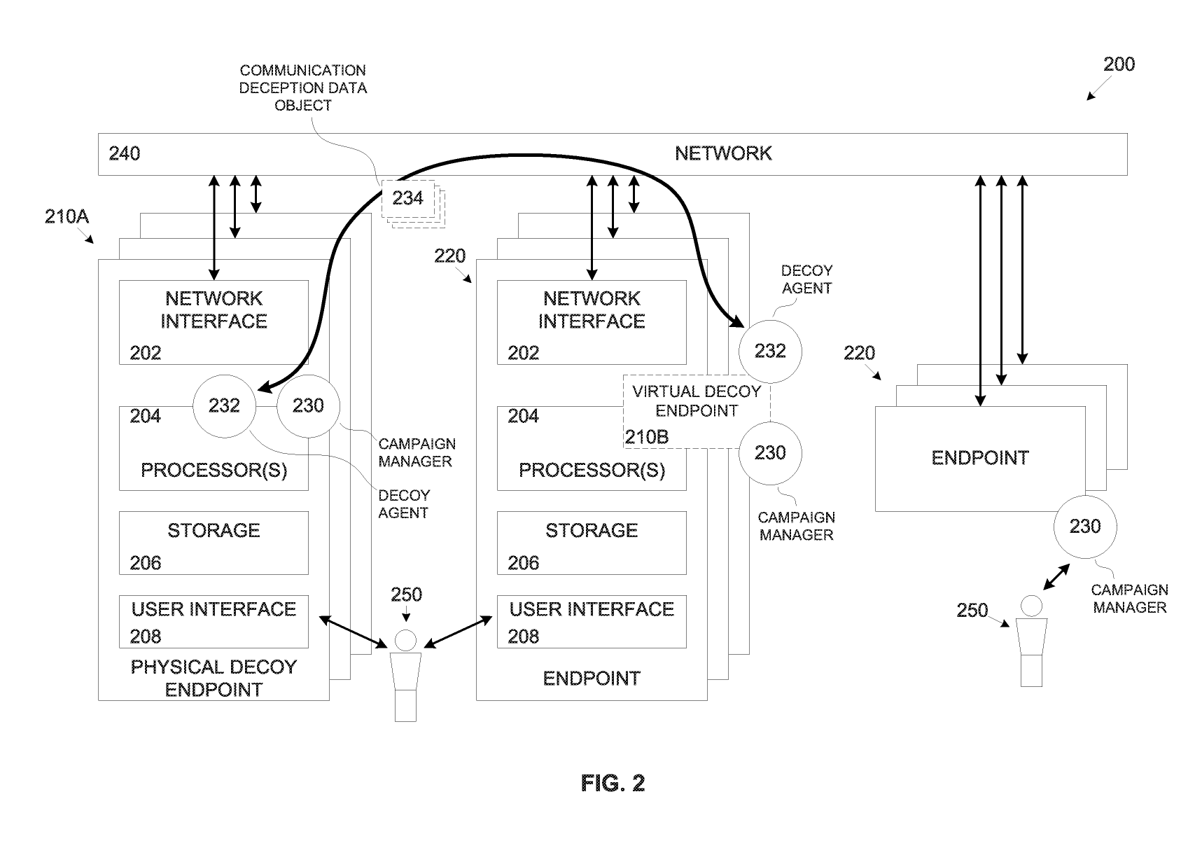

Reference is also made to FIG. 2, which is a schematic illustration of an exemplary protected network comprising means for creating, injecting and monitoring deception traffic in the protected network to detect potential unauthorized operations, according to some embodiments of the present invention. A process such as the process 100 may be executed in an exemplary protected network 200 to launch one or more deception campaigns for detecting and/or alerting of potential unauthorized operations in the protected network 200 comprising a plurality of endpoints 220 connected to a network 240. The protected network 200 may facilitate, for example, an organization network, an institution network and/or the like. The protected network 200 may be deployed as a local protected network that may be a centralized in single location where all the endpoints 220 are on premises or the protected network 200 may be a distributed network where the endpoints 220 may be located at multiple physical and/or geographical locations. Moreover, the protected network 200 may be divided to a plurality of network segments which may each host a subset of the endpoints 220. Each of the network segments may also be characterized with different characteristics, attributes and/or operational parameters.

The network 240 may be facilitated through one or more network infrastructures, for example, a Local Area Network (LAN), a Wide Area Network (WAN), a Personal Area Network (PAN), a Metropolitan Area Network (MAN) and/or the like. The network 240 may further include one or more virtual networks hosted by one or more cloud services, for example, Amazon Web Service (AWS), Google Cloud, Microsoft Azure and/or the like. The network 240 may also be a combination of the local protected network and the virtual protected network.

The endpoints 220 may include one or more physical endpoints, for example, a computer, a workstation, a server, a processing node, a cluster of processing nodes, a network node, a Smartphone, a tablet, a modem, a hub, a bridge, a switch, a router, a printer and/or any network connected device having one or more processors. The endpoints 220 may further include one or more virtual endpoints, for example, a virtual machine (VM) hosted by one or more of the physical devices, instantiated through one or more of the cloud services and/or provided as a service through one or more hosted services available from the cloud service(s). The virtual device may provide an abstracted and platform-dependent and/or independent program execution environment. The virtual device may imitate operation of dedicated hardware components, operate in a physical system environment and/or operate in a virtualized system environment. The virtualization infrastructure may utilize, for example, Elastic Sky X (ESXi), XEN, Kernel-based Virtual Machine (KVM) and/or the like.

Each of the endpoints 220 may include a network interface 202 for communicating with the network 230, a processor(s) 204 and a storage 206. The processor(s) 204, homogenous or heterogeneous, may include one or more processing nodes arranged for parallel processing, as clusters and/or as one or more multi core processor(s). The storage 206 may include one or more non-transitory persistent storage devices, for example, a hard drive, a Flash array and/or the like. The program store 204 may further comprise one or more network storage devices, for example, a storage server, a network accessible storage (NAS), a network drive, and/or the like. The storage 206 may also include one or more volatile devices, for example, a Random Access Memory (RAM) component and/or the like.

The processor(s) 204 may execute one or more software modules, for example, an OS, an application, a tool, an agent, a service, a script and/or the like wherein a software module comprises a plurality of program instructions that may be executed by the processor(s) 204 from the storage 206.

The system 200 further includes one or more decoy endpoints 210 such as the endpoints 220. Similarly to the endpoints 220, the decoy endpoint(s) 210 may include one or more physical decoy endpoints 210A employing a naïve implementation over one or more physical devices. Optionally, the decoy endpoints 210 may include one or more virtual decoy endpoints 210B, for example, a nested VM hosted by one or more of the physical endpoints 220 and/or by one or more of the physical decoy servers 210A.

Each of the decoy endpoints 210 may execute a decoy agent 232 comprising one or more software modules for injecting, transmitting, receiving and/or the like deception traffic (communication) in the network 240. Moreover, one or more of the plurality of the regular (general) endpoints 220 may be configured as a decoy endpoint 210 by deploying the decoy agent 232 on the respective endpoint(s) 220. One or more of the decoy endpoints 210 may further execute a deception campaign manager 230 to create, launch, control and/or monitor one or more deception campaigns in the protected network 200 to detect potential unauthorized operations in the protected network 200. Each deception campaign may include deploying one or more decoy endpoints 210, instructing the decoy agents 232 to transfer the deception network traffic, monitoring and analyzing the network 240 to identify usage of deception data contained in the deception traffic and taking one or more actions based on the detection. Optionally, the deception campaign manager 230 is executed by one or more of the endpoints 220. Optionally, at least some functionality of the campaign manager 230 is integrated in the decoy agent, in particular, monitoring and analyzing the network traffic to identify usage of the deception data and/or the like.

Optionally, one or more of the endpoints 220 as well as one or more of the decoy endpoints 210 include a user interface 208 for interacting with one or more users 250, for example, an information technology (IT) officer, a cyber security person, a system administrator and/or the like. The user interface 208 may include one or more human-machine interfaces (HMI), for example, a text interface, a pointing devices interface, a display, a touchscreen, an audio interface and/or the like which allow interaction with the user 250. The user interface may include, for example, a graphic user interface (GUI) utilized through one or more of the human-machine interface(s).

In case of the physical decoy endpoint(s) 210A, the user 250 may use the user interface 208 of the physical decoy endpoint 210A to interact with one or more of the software modules executed by the decoy endpoint 210A, for example, the campaign manager 230. In case of the virtual decoy endpoint(s) 210B, the user 250 may use the user interface 208 of the endpoint 220 hosting the virtual decoy endpoint 210B to interact with one or more of the software modules executed by the virtual decoy endpoint 210B, for example, the campaign manager 230. Similarly, in case the campaign manager 230 is executed by one of the endpoints 220 (physical and/or virtual), the user 250 may use the respective user interface 208 to interact with the campaign manager 230. Optionally, the user 250 interacts with the campaign manager 230, remotely using one or more applications, for example, a local agent, a web browser and/or the like executed by one or more of the endpoints 220.

The process 100 may be executed by the campaign manager 230. The user 250 may use the campaign manager 230 to launch one or more of the deception campaigns comprising deploying the decoy endpoints 210, creating, adjusting, configuring and/or launching the decoy agents 232, instructing the decoy agents 232 to transmit deception traffic over the network 240, monitoring the network activity (traffic), identifying usage of communication deception data objects 234 contained in the deception traffic and taking one or more actions according to the detection. The user 250 may further use the campaign manager 230 to create, create, define, deploy and/or update a plurality of communication deception data objects 234 (breadcrumbs) in one or more of the decoy endpoints 210 in the protected network 200, in particular using the decoy agents 232. The deployed communication deception data objects 234 may include deception data configured to tempt the potential attacker(s), for example, a user, a process, a utility, an automated tool, an endpoint and/or the like attempting to access resource(s) in the protected network 200 to use the deception data objects 234. The communication deception data objects 234 may be configured and encoded according to one or more communication protocols used in the protected network 200 to emulate real, valid and/or genuine data objects that may be typically transmitted over the network 240. The communication deception data objects 234 may further be automatically created, updated, adjusted and/or the like by the campaign manager 230, in particular in response to detecting one or more of the unauthorized operations. The campaign manager 230 may automatically create, update and/or adjust the communication deception data objects 234 according to the detected unauthorized operation(s) which may be indicative of an attack vector applied by the potential attacker(s).

In order to launch effective and/or reliable deception campaigns, the deception environment may be designed, created and deployed to follow communication protocols as well as design patterns, which may be general reusable solutions to common problems and are in general use. The deception campaign may be launched to emulate one or more of the design patterns and/or best-practice solutions that are widely used by a plurality of organizations. Applying this approach may give a reliable impression of the deception traffic to appear as real, valid and/or genuine network traffic thus effectively attracting and/or misleading the potential attacker who may typically be familiar with the applied communication protocols and/or design patterns.

Optionally, one or more of the deception campaigns may target one or more segments of the protected network 200, for example, a subnet, a subdomain and/or the like. The protected network 200 may typically compose of a plurality of network segments for a plurality of reasons, for example, network partitioning, network security, access limitation and/or the like. Each of the segments may be characterized by different operational characteristics, attributes and/or parameters, for example, domain names, access privileges, traffic priorities and/or the like. The deception campaigns may therefore be adjusted and launched for certain segment(s) in order to better adjust to the operational characteristics of the segment(s). Such approach may further allow for better classification of the potential attacker(s) and/or of identification and characterization of the attack vector(s). The groups may also be defined according to one or more other characteristics of the protected network 235, for example, a subnet, a subdomain, an active directory, a type of application(s) 222 used by the group of users, an access permission on the protected network 235, a user type and/or the like.

As shown at 102, the process 100 for launching one or more deception campaigns starts with the user 250 using the campaign manager 230 to create, adjust, configure and deploy one or more decoy endpoints 210 in the protected network 200 and/or one or more segments of the protected network 200. Deploying the decoy endpoints 210 further includes deploying the decoy agents 230 on the created and deployed decoy endpoints 210. Naturally, in order to create a reliable deception environment, using the campaign manager 230, the user 250 may configure the decoy endpoints 210 according to the type, operational characteristics and/or the like of the endpoints 220. Similarly, using the campaign manager 230, the user 250 may select, configure and deploy the decoy agents 232 according to the communication protocols used in the protected network 200. In the manner, using the campaign manager 230, the user 250 may select, configure and adjust one or more of the communication deception data objects 234 encoded according to the communication protocols used in the protected network 200. The communication deception data objects 234 may include, for example, a hashed credentials object, a browser cocky, a registry key, a Domain Network Server (DNS) name, an Internet Protocol (IP) address, a Server Message Block (SMB) message, a Link-Local Multicast Name Resolution LLMNR) message, a NetBIOS Naming Service (NBNS) message, a Multicast Domain Name System (MDNS) message, an Hypertext Transfer Protocol (HTTP) message, and/or the like. Each of the communication deception data objects 234 messages may include one or more packets encoded and/or configured according to the respective communication protocol.

For example, assuming a DNS service is used in the protected network 200 and/or segment(s) of it. Using the campaign manager 230, one or more decoy agents 232 as well as one or more communication deception data objects 234 may be selected and/or created according to the DNS protocol(s). The communication deception data objects 234 may be configured to include an IP address of a third decoy endpoint 210 which is not used by legitimate users in the protected network 200. In another example, assuming a certain authentication session is typically used by the endpoints 220 using hashed credentials. Using the campaign manager 230, one or more communication deception data objects 234 may be created according to the structure of the hashed credentials and configured to include fake credentials. In another example, which may be typical to an Internet of Things (IoT) deployment, using the campaign manager 230, one or more IoT like decoy endpoints 210 may be deployed. The IoT decoy endpoints 210 may be assigned with one or more network addresses according to the IoT protocols. In another example, using the campaign manager 230, one or more fake credit card numbers may be created and encoded in one or more of the communication deception data objects 234.

Moreover, the communication deception data objects 234 are directed to attract the potential attackers, for example, a user, a process, a utility, an automated tool, an endpoint and/or the like during the OODA process in the protected network 200. To create an efficiently deceptive campaign, the communication deception data objects 234 may be created with one or more attributes that may be attractive to the potential attacker, for example, a name, a type and/or the like. The communication deception data objects 234 may be created to attract the attention of the attacker using an attacker stack, i.e. tools, utilities, services, application and/or the like that are typically used by the attacker. As such, the communication deception data objects 234 may be transparent to users using a user stack, i.e. tools, utilities, services, application and/or the like that are typically used by a legitimate user. Taking this approach may allow creating the deception campaign in a manner that the user may need to go out of his way, perform unnatural operations and/or actions to detect, find and/or use the communication deception data objects 234 while it may be a most natural course of action or method of operation for the attacker.

Optionally, the campaign manager 230 provides one or more generic templates for creating the decoy endpoints 210, the decoy agents 232 and/or the communication deception data objects 234. The template(s) may be adjusted according to one or more characteristics of the protected network 200, for example, the communication protocols used in the protected network 200, domain name(s) in the protected network 200, rules for assigning account names, passwords, etc. in the protected network 200. For example, the user 250 may adjust a certain template used to create one or more of the decoy endpoints 210 and/or one or more of the decoy agents 232 to use a specific domain name used in the protected network 200. In another example, the user 250 may adjust a certain template used to create one or more of the decoy endpoints 210 and/or one or more of the decoy agents 232 to use specific fake account name(s) which follow account name assignment rules applied in the protected network 200. The adjusted template(s) may be defined as a baseline which may be dynamically updated in real time by the campaign manager 230 according to the detected unauthorized operations. Optionally, the campaign manager 230 supports defining the template(s) to include orchestration, provisioning and/or update services for the decoy endpoints 210 and/or the decoy agents 232 to ensure that the instantiated templates are up-to-date with the communication protocols and/or deployment practices applied in the protected network 200.

As shown at 104, the campaign manager 230 may instruct one or more of the decoy agents 232 to transmit deception traffic (communication) comprising one or more of the communication deception data objects 234 over the network 240. The campaign manager 230 may instruct the decoy agent(s) 232 to transmit the communication deception data object(s) 234 to one or more other decoy agents 232 executed by other decoy endpoints 210, for example, a third decoy endpoint 210. Optionally, the instruction to transmit the deception traffic may be automated such that once deployed, the decoy agents 232 may start transmitting their respective communication deception data object(s) 234. As one or more of the decoy agents 232 may include at least some functionality of the campaign manger 230, the instruction to transmit the communication deception data object(s) 234 may originate from the decoy agent(s) 232 themselves.

Optionally, the campaign manager 230 may instruct the decoy agent(s) 232 to broadcast the communication deception data object(s) 234 over the network 240 and/or segment(s) of the network 240. Any device connected to the network 240 and/or the respective segment(s), in particular the potential attacker(s) who may sniff the network activity one the network 240 may therefore intercept the broadcasted communication deception data object(s) 234.

As shown at 106, the campaign manager 230 monitors the a plurality of operations initiated in the protected network 200 to identify usage of deception data contained in one or more of the communication deception data objects 234. The monitoring conducted by the campaign manager 230 may include monitoring the network activity of the data transferred over the network 240 and/or a part thereof to detect the usage of deception data contained in one or more of the communication deception data objects 234. The campaign manager 230 may further monitor usage of the deception data contained in the communication deception data objects 234 for accessing and/or using one or more of the endpoints 220, in particular the decoy endpoint(s) 210. Moreover, the campaign manager 230 may use one or more applications, services and/or systems available in the protected system 200 to detect the usage of the communication deception data objects 234 and/or deception data contained thereof. As one or more of the decoy agents 232 may include at least some functionality of the campaign manger 230, for example, monitoring the network activity on the network 240, the monitoring may be further conducted by the decoy agent(s) 232. Since the deception traffic may be transparent and/or not used by legitimate users in the protected network 200, usage of the deception data contained in the communication deception data objects 234 may typically be indicative of a potential cyber security threat imposed by the potential attacker(s).

To continue the previous examples, the campaign manager 230 may detect the usage of the IP address of the third decoy endpoint 210 which was included in the communication deception data object(s) 234 transmitted between the decoy agents 232. Such usage may be identified when the IP address is used to access the third decoy endpoint 210. In another example, the campaign manager 230 may detect the usage of the fake credentials included in the communication deception data object(s) 234 transmitted between the decoy agents 232. Such usage may be identified, for example, when the fake credentials are used in an authentication process to access one or more decoy endpoints 210, one or more decoy agents 232 and/or the like. In another example, the campaign manager 230 may detect the usage of the address of the IoT decoy endpoints 210 in an access attempt to the IoT decoy endpoints 210. In another example, the campaign manager 230 may detect the usage of one or more of the fake credit card numbers encoded in certain communication deception data objects 234. Moreover, the campaign manager 230 may detect the usage of the fake credit card numbers by using and/or interacting with one or more of the services and/or systems already available in the protected system, for example, a credit card clearing system and/or service.

As shown at 108, the campaign manager 230 may analyze the detected usage of the deception data contained in the communication deception data object(s) 234. Based on the analysis the campaign manager 230 may identify one or more unauthorized operations which may typically be indicative of a potential threat from the potential attacker(s) attacking one or more resources of the protected network 200.

For example, in case the campaign manager 230 identifies that the fake hashed credentials object is used to access a certain decoy endpoint 210 and/or a certain decoy agent 232, the campaign manager 230 may determine that an attacker has applied one or more attack vectors, for example, pass the hash. A pass the hash attack is a hacking technique in which an attacker authenticates to certain one or more endpoints 220 and/or services executed by the endpoint(s) 220 using the underlying hash codes of a user's password. In particular, the attacker may sniff the network 240 and intercept the fake hashed credentials object transmitted by the certain decoy endpoint 210. Therefore, in case the campaign manager 230 identifies that the fake hashed credentials object is used to access the respective decoy endpoint 210 and/or the respective decoy agent 232, the campaign manager 230 may determine that an attacker has applied a pass the hash attack vector in the protected system 200.

In another example, based on the analysis, the campaign manager 230 may identify one or more responder (“man in the middle”) attack vector(s) operation(s) which may be initiated using one or more automated tools, for example, Metasploit, Powershell, Reponder.py and/or the like which may sniff the network 240 to intercept communication data and initiate one or more operations which are naturally unauthorized. The responder attack vector may target a plurality of communication protocols, for example, LLMNR, NBNS, MDNS, SMB, HTTP and more. In such an attack vector the attacker may relay and possibly alter communication data between two endpoints 220 who believe they are directly communicating with each other. The attacker may use a rouge authentication server in order to obtain a credentials object during an authentication between two endpoints 220. The automated tool(s) may then use the obtained credentials to continue the authentication sequence and access one or more endpoints 220 and/or applications, services and/or the like executed by the endpoints 220. Therefore, in case the campaign manager 230 identifies that the fake credentials object is used to access the respective decoy endpoint 210 and/or the respective decoy agent 232, the campaign manager 230 may determine that an attacker has applied a responder attack vector in the protected system 200.

In another example, the campaign manager 230 may identify an attempt to access a certain decoy endpoint 210 using deception data, for example, a password, an account name, an IP address and/or the like which were included in one or more of the deception communication objects 234. In such case the campaign manager 230 may determine that an attacker has intercepted the deception data and is using it to access the certain decoy endpoint.

Optionally, the campaign manager 230 communicates with one or more automated systems deployed in the protected network 200 to detect the usage of the deception data contained in communication deception data object(s) 234 intercepted by the potential attacker. The automated systems, for example, a security system, a Security Operations Center (SOC), a Security Information and Event Management (STEM) system (e.g. Splunk or ArcSight) and/or the like typically monitor and/or log a plurality of operations conducted in the protected network 200. The campaign manager 230 may therefore take advantage of the automated system(s) and communicate with them to obtain the monitored and/or logged information to detect the usage of the deception data. For example, the campaign manager 230 may analyze a log record and/or a message received from the STEM system. Based on the analysis the campaign manager 230 may identify an access to a certain decoy endpoint 210 using the deception data, for example, a password, an account name, an IP address and/or the like which were included in one or more of the deception communication objects 234. In such case the campaign manager 230 may determine that an attacker has intercepted the deception data and is using it to access the certain decoy endpoint.

Optionally, the campaign manager 230 creates one or more activity patterns of the potential attacker(s) by analyzing the identified unauthorized operation(s). Using the activity pattern(s), the campaign manager 230 may gather useful forensic data on the operations of the potential attacker and may classify the potential attacker in order to estimate a course of action, attack vector characteristic(s), attack technique(s) and/or intentions of the potential attacker. Such information may be used by the campaign manager 230 to take further one or more actions, for example, a deception action, a preventive action and/or a containment action to encounter the predicted next operation(s) of the potential attacker(s).

Optionally, the campaign manager 230 employs one or more machine learning processes, methods, algorithms and/or techniques on the identified activity pattern(s) to further collect analytics data regarding the activity patterns. The machine learning analytics may serve to increase the accuracy of classifying the potential attackers based on the activity pattern(s) and better predict further activity and/or intentions of the potential attacker(s) in the protected network 200.

As shown at 110, the campaign manager 230 may initiate one or more actions according to the detected unauthorized operations. The campaign manager 230 may generate one or more alerts indicting of the potentially unauthorized operation. The user 250 may configure the campaign manager 230 to set an alert policy defining one or more of the operations and/or combination of operations that trigger the alert(s). The campaign manager 230 may be configured during the creation of the deception campaign and/or at any time after the deception campaign is launched. The alert may be delivered to one or more parties, for example, the user 250 monitoring the campaign manager 230 and/or through any other method, for example, an email message, a text message, an alert in a mobile application and/or the like. The campaign manager 230 may be further configured to deliver the alert(s) to one or more automated systems, for example, the security system, the SOC, the SIEM system and/or the like.

The campaign manager 230 may configured to take one or more additional actions following the detection of the unauthorized operations.

The campaign manager 230 may apply one or more automated tools to automatically update, adjust extend and/or the like the deception environment by initiating one or more additional communication session between the decoy agents 232 to inject additional deception traffic into the network 240. The additional deception traffic may include one or more additional communication deception data objects 234 which may be automatically selected, created, configured and/or adjusted according to the detected unauthorized operations in order to contain the detected attack vector, in order to collect forensic data relating to the attack vector and/or the like.

The campaign manager 230 may further initiate one or more communication session with the attacker(s), for example, in case of a responder attack vector, the campaign manager 230 may initiate communication session(s) with the responder device. The communication session(s) with the responder may be conducted by the campaign manager 230 itself and/or by one or more of the decoy agents 232. The communication session(s) may typically also include one or more communication deception data objects 234 automatically selected, created, configured and/or adjusted according to the detected unauthorized operations.

The campaign manager 230 may further adapt the deception traffic to tackle the estimated course of action and/or intentions of the potential attacker based on the identified activity pattern(s) of the potential attacker(s). The campaign manager 230 may further use the machine learning analytics to adjust the additional deception traffic according to the classification of the potential attacker(s) and/or according to the predicted intentions and/or activity in the protected network 200.

It is expected that during the life of a patent maturing from this application many relevant systems, methods and computer programs will be developed and the scope of the terms endpoint, communication protocols and attack vectors are intended to include all such new technologies a priori.

As used herein the term “about” refers to ±10%. The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method of detecting unauthorized access to a protected network by detecting a usage of dynamically updated deception communication, comprising:
Deploying, in a protected network comprising a plurality of endpoints, a plurality of decoy endpoints configured to transmit at least one communication deception data object encoded according to at least one communication protocol used in the protected network;
instructing a first decoy endpoint of the plurality of decoy endpoints to transmit the at least one communication deception data object to a second decoy endpoint of the plurality of decoy endpoints;
monitoring the protected network to detect a usage of data contained in the at least one communication deception data object;
detecting at least one potential unauthorized operation based on analysis of the detection; and
initiating at least one action according to the detection.

2. The computer implemented method of claim 1, wherein each of the plurality of endpoints is a member of a group consisting of: a physical device comprising at least one processor and a virtual device hosted by at least one physical device.

3. The computer implemented method of claim 1, wherein at least one of said plurality of endpoints is configured as one of said plurality of decoy endpoints.

4. The computer implemented method of claim 1, wherein the at least one communication deception data object is a member of a group consisting of: a hashed credentials object, a browser cocky, a registry key, a Domain Network Server (DNS) name, an Internet Protocol (IP) address, a Server Message Block (SMB) message, a Link-Local Multicast Name Resolution LLMNR) message, a NetBIOS Naming Service (NBNS) message, a Multicast Domain Name System (MDNS) message and an Hypertext Transfer Protocol (HTTP).

5. The computer implemented method of claim 1, wherein the transmitting further comprising broadcasting the at least one communication deception data object in the protected network.

6. The computer implemented method of claim 1, further comprising deploying at least two of the plurality of decoy endpoints in at least one segment of the protected network.

7. The computer implemented method of claim 1, wherein the monitoring comprises at least one of:
monitoring the network activity in the protected network, and
monitoring an access to at least one of the plurality of decoy endpoints.

8. The computer implemented method of claim 1, wherein the at least one potential unauthorized operation is initiated by a member of a group consisting of: a user, a process, an automated tool and a machine.

9. The computer implemented method of claim 1, further comprising providing a plurality of templates for creating at least one of: the plurality of decoy endpoints and the at least one communication deception data object.

10. The computer implemented method of claim 9, further comprising at least one of the plurality of templates is adjusted by at least one user according to at least one characteristic of the protected network.

11. The computer implemented method of claim 1, wherein the at least one action comprising generating an alert at detection of the at least one potential unauthorized operation.

12. The computer implemented method of claim 1, wherein the at least one action comprising communicating with a potential malicious responder using the at least one communication deception data object.

13. The computer implemented method of claim 1, further comprising the at least one communication deception data object relates to a third decoy endpoint of the plurality of endpoints.

14. The computer implemented method of claim 1, further comprising analyzing the at least one potential unauthorized operation to identify at least one activity pattern.

15. The computer implemented method of claim 14, further comprising applying a learning process on the at least one activity pattern to classify the at least one activity pattern in order to improve detection and classification of at least one future potential unauthorized operation.

16. A system for detecting unauthorized access to a protected network by detecting a usage of dynamically updated deception communication, comprising:
at least one processor of at least one decoy endpoint adapted to execute code, the code comprising:
code instructions to deploy, in a protected network comprising a plurality of endpoints, a plurality of decoy endpoints configured to transmit at least one communication deception data object encoded according to at least one communication protocol used in the protected network;
code instructions to instruct a first decoy endpoint of the plurality of decoy endpoints to transmit the at least one communication deception data object to a second decoy endpoint of the plurality of decoy endpoints;
code instructions to monitor the protected network to detect a usage of data contained in the at least one communication deception data object;
code instructions to detect at least one potential unauthorized operation based on analysis of the detection; and
code instructions to initiate at least one action according to the detection.

17. A software program product for detecting unauthorized access to a protected network by detecting a usage of dynamically updated deception communication, comprising:
a non-transitory computer readable storage medium;
first program instructions for deploying, in a protected network comprising a plurality of endpoints, a plurality of decoy endpoints configured to transmit at least one communication deception data object encoded according to at least one communication protocol used in the protected network;
second program instructions for instructing a first decoy endpoint of the plurality of decoy endpoints to transmit the at least one communication deception data object to a second decoy endpoint of the plurality of decoy endpoints;
third program instructions for monitoring the protected network to detect a usage of data contained in the at least one communication deception data object;
fourth program instructions for detecting at least one potential unauthorized operation based on analysis of the detection; and
fifth program instructions for initiating at least one action according to the detection;
wherein the first, second, third, fourth and fifth program instructions are executed by at least one processor from the non-transitory computer readable storage medium.
